(19) United States
(12) Patent Application Publication
(10) Pub. No.: US 2016/0062356 A1
(43) Pub. Date: Mar. 3, 2016

(54) SYSTEMS FOR VEHICLE CONTROL

(71) Applicant: General Electric Company, Schenectady, NY (US)

(72) Inventors: Bret Dwayne Worden, Erie, PA (US); Nicholas Edward Roddy, Schenectady, NY (US); Feng Xue, Clifton Park, NY (US); Dustin Garvey, San Ramon, CA (US)

(21) Appl. No.: 14/936,670

(22) Filed: Nov. 9, 2015

Related U.S. Application Data
(63) Continuation-in-part of application No. 13/554,808, filed on Jul. 20, 2012, now abandoned.

(51) Int. Cl. G05D 1/00; G07C 5/00

(52) U.S. Cl. CPC G05D 1/0027; G05D 1/0022; G05D 1/0055; G07C 5/008

(57) ABSTRACT

A vehicle control system includes a transceiver and a control unit. The transceiver is configured to communicate with plural vehicles, to receive operational parameter values from the plural vehicles. The operational parameter values are generated by sensors on board the vehicles and relate to operation of the vehicles during movement of the vehicles along one or more routes. The control unit is configured to generate respective vehicle operational assessments of the vehicles based on the received operational parameter values. The vehicle operational assessments are representative of respective states of operational readiness of the vehicles. The control unit is further configured to generate control signals, relating to control of the vehicles for operation along the one or more designated routes, based on the operational assessments. The control signals are configured to control at least one device, either on board or off board the vehicles.

### CROSS-REFERENCE TO RELATED APPLICATIONS

This application is a continuation-in-part of U.S. application Ser. No. 13/554,808, filed Jul. 20, 2012, which is hereby incorporated herein in its entirety.

### BACKGROUND

1. Technical Field

Embodiments of the subject matter disclosed herein relate to systems for vehicle control.

2. Discussion of Art

When a fleet vehicle (e.g., a vehicle from a group of vehicles owned and operated by an entity for some common purpose, such as goods delivery, freight transport, people moving, etc.) is selected for use, it may be the case that the vehicle, unbeknownst to the operator, is in poor health relative to other available vehicles. This results in a greater chance of the vehicle experiencing a mechanical failure or other problem while it is being used, relative to other vehicles in the fleet.

Therefore, it may be desirable to provide a system for vehicle control, which decreases the likelihood of a vehicle failure while the vehicle is being operated along a route.

### BRIEF DESCRIPTION

In an embodiment, a vehicle control system includes a transceiver and a control unit. The transceiver is configured to communicate over one or more communication channels with plural communication units on board respective plural vehicles, to receive respective pluralities of first operational parameter values from the plural vehicles. The respective pluralities of first operational parameter values are generated at least in part by sensors on board the vehicles and relate at least in part to operation of the vehicles during movement of the vehicles along one or more routes. The control unit is configured to generate plural respective vehicle operational assessments of the vehicles based on the pluralities of first operational parameter values received from the vehicles. The vehicle operational assessments are representative of respective states of operational readiness of the vehicles. The control unit is further configured to generate control signals, relating to control of the vehicles for operation along the one or more designated routes, based on the operational assessments. The control signals are configured to control at least one device, either on board or off board the vehicles.

In an embodiment, a vehicle control system includes a transceiver and a control unit. The transceiver is configured to communicate over one or more communication channels with plural communication units on board respective plural vehicles, to receive respective pluralities of first operational parameter values from the plural vehicles. The respective pluralities of first operational parameter values are generated at least in part by sensors on board the vehicles and relate at least in part to operation of the vehicles during movement of the vehicles along one or more routes. The control unit is configured to generate plural respective vehicle operational assessments of the vehicles based on the pluralities of first operational parameter values received from the vehicles. The vehicle operational assessments are representative of respective states of operational readiness of the vehicles. The control unit is further configured to determine respective operational capabilities of the vehicles to operate along one or more designated routes according to one or more designated criteria, based at least in part on the vehicle operational assessments that are generated. The control unit is further configured to generate control signals, relating to control of the vehicles for operation along the one or more designated routes, based on the operational capabilities that are determined. The control signals are configured to control at least one device, either on board or off board the vehicles.

### BRIEF DESCRIPTION OF THE DRAWINGS

Reference is made to the accompanying drawings in which particular embodiments of the invention are illustrated as described in more detail in the description below. Like reference numerals designate identical or corresponding parts throughout the several views. However, the inclusion of like elements in different views does not mean a given embodiment necessarily includes such elements or that all embodiments of the invention include such elements.

FIG. 1 is a schematic view of a vehicle control system, according to an embodiment.

FIG. 2 is a schematic view of a vehicle control system, according to another embodiment.

FIG. 3 is an illustration of a first exemplary embodiment of a system for characterizing the health of a set of client assets, ranking the client assets according to the characterized health, and allocating one or more of the client assets for a task or mission.

FIG. 4 is an illustration of a second exemplary embodiment of a system for characterizing the health of a set of client assets, ranking the client assets according to the characterized health, and allocating one or more of the client assets for a task or mission.

FIG. 5 is an illustration of an exemplary embodiment of a server architecture used in the systems of FIG. 2 and FIG. 3.

FIG. 6 illustrates a flow chart of an exemplary embodiment of a method for characterizing the health of a set of client assets, ranking the client assets according to the characterized health, and allocating one or more of the client assets for a task or mission using the system of FIG. 2 or FIG. 3.

### DETAILED DESCRIPTION

In an embodiment, a vehicle control system is configured to generate control signals, relating to controlling plural vehicles for travel along one or more designated routes, based on operational assessments of the vehicles that are determined using operational parameter values received from the vehicles (e.g., sensor data) or otherwise. For example, the control system may be configured to rank the vehicles according to the operational assessments, and to generate the control signals, for the vehicles to travel along the designated routes, based on the ranking and/or designated criteria (e.g., mission parameters).

The term “client asset” as used herein means a fixed asset or a mobile asset that is owned and/or operated by a client entity such as, for example, a railroad, a power generation company, a mining equipment company, an airline, or any other asset-owning and/or asset-operating entity. One example of a class or type of client asset is rail vehicles or other vehicles.

The term “operational parameter values” (or “operational parameter data”) as used herein means values or data relating to and/or collected from client asset operation (e.g., vehicle operation), maintenance records, periodic inspection data (e.g., oil samples taken from a locomotive or other vehicle), or incidents generated by control systems on board a vehicle or other client asset.

As used herein, an example of a designated condition of a vehicle or other asset is when the vehicle meets a determined standard or baseline of performance. (For example, the term “healthy asset” (e.g., healthy vehicle) as used herein means a vehicle or other asset that meets some determined standard or baseline of performance.) Another example of a designated condition of a vehicle or other asset is when the vehicle is capable of travel along a designated route according to one or more criteria.

In aspects, “operational assessment” as used herein may mean an indication of a relative or absolute operational capability or performance of a vehicle or other asset, a sub-system of a vehicle or other asset, or a fleet of vehicles or other assets. One example of an operational assessment as used herein is a health score.

The term “sampled” as used herein means sensed, measured, captured, or collected, when referring to operational parameter data or operational parameter values. In one specific example, sampled refers to collecting data at plural periodic or repeating discrete points in time, for a designated or determined length of time.

In aspects, the term “parameter set” refers to a set of data or other information that relates to and/or is representative of a vehicle or other asset having a designated condition. One example is a parameter model, referring to a computer program, an electronic table, or some other data set or equivalent thereof that is representative of a standard or baseline healthy vehicle or other asset.

The term “determined” as used herein may mean defined, calculated, or preset.

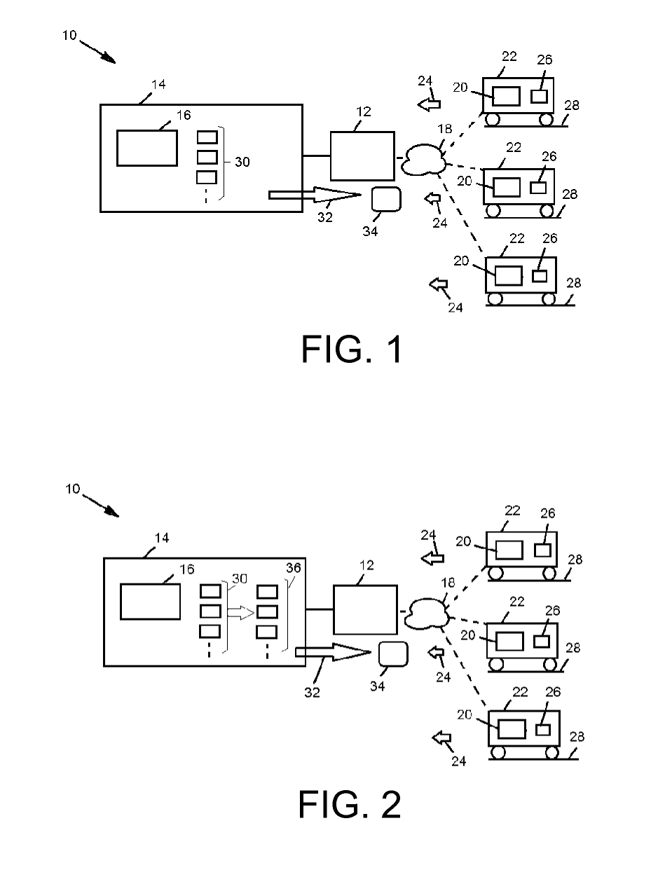

Referring to FIG. 1, an embodiment of a vehicle control system 10 includes a transceiver 12 and a control unit 14. The control unit may include one or more processors 16. The transceiver 12 is configured to communicate over one or more communication channels 18 (e.g., of a communication network) with plural communication units 20 on board respective plural vehicles 22, to receive respective pluralities of first operational parameter values 24 from the plural vehicles. The respective pluralities of first operational parameter values 24 are generated at least in part by sensors 26 on board the vehicles and relate at least in part to operation of the vehicles during movement of the vehicles along one or more routes 28. The control unit is configured to generate plural respective vehicle operational assessments 30 (e.g., health scores) of the vehicles based on the pluralities of first operational parameter values received from the vehicles. The vehicle operational assessments are representative of respective states of operational readiness of the vehicles. The control unit is further configured to generate control signals 32, relating to control of the vehicles for operation along the one or more designated routes, based on the operational assessments. For example, the control unit may be configured to generate the control signals based on a ranking of the operational assessments relative to one another. The control signals are configured to control at least one device 34, either on board or off board the vehicles.

For example, the control signals 32 may be configured to control a vehicle scheduling system for generating schedules of the vehicles to travel along the route(s). As another example, alternatively or additionally, the control signals may be configured to control a display device (e.g., display device of a tablet, laptop computer or computer, smartphone, etc.) for displaying the operational assessments, a ranking of the vehicles, a selected vehicle, etc. to an operator. As another example, alternatively or additionally, the control signals may be configured to control (directly or indirectly) a device or devices on board one or more of the vehicles, e.g., for automatic control of the vehicles for movement along the route(s). As another example, alternatively or additionally, the control signals may be configured to control a trip planning system, on or off board the vehicles, which is configured to generate trip plans for automatic or other control of the vehicles. For example, a control system on board the vehicle may be configured to control a throttle or braking system of the vehicle based on a trip plan, to achieve designated objectives, or to display the throttle or brake settings to an operator for the operator to control the vehicle, again, to achieve designated objectives.

With reference to FIG. 2, in another embodiment, the control unit is further configured to determine respective operational capabilities 36 of the vehicles to operate along one or more designated routes according to one or more designated criteria, based at least in part on the vehicle operational assessments 30 (e.g., health scores) that are generated. The control unit is further configured to generate the control signals, relating to control of the vehicles for operation along the one or more designated routes, based on the operational capabilities 36 that are determined. The control signals are configured to control at least one device, either on board or off board the vehicles. As should be appreciated, whereas an operational assessment of a vehicle is representative of a state of operational readiness of the vehicle (e.g., vehicle health) generally, the operational capability in effect relates to the operational assessment as applied to a particular route or routes, according to one or more criteria. Examples are discussed below.

In another embodiment, the control unit is configured to generate each operational assessment of the plural operational assessments relative to the vehicle associated with the operational assessment and not with respect to a standard and/or a baseline.

In another embodiment, the control unit is configured to generate each operational assessment of the plural operational assessments by comparing the first operational parameter values of the vehicle associated with the operational assessment to a corresponding parameter set (e.g., parameter model) representative of a vehicle having a designated condition (e.g., healthy vehicle). Aspects of this embodiment are further discussed below. The operational assessment may represent a total deviation of the first operational parameter values of the vehicle associated with the operational assessment from the parameter set.

In another embodiment, the respective pluralities of first operational parameter values of the plural vehicles are further generated by sampling outputs of the sensors over a determined length of time during operation of the vehicles. The control unit is configured to generate the parameter set (e.g., parameter model) based on a plurality of second operational parameter values received from the vehicle having the designated condition (e.g., the healthy vehicle). The plurality of second operational parameter values are sampled from sensor outputs of sensors on board the vehicle having the designated condition over the determined length of time.

In another embodiment, the control unit is configured to generate the parameter set to include a plurality of principal components derived from a plurality of second operational parameter values received from the vehicle having a designated condition, as discussed further below.

In another embodiment, the control unit is configured to generate the parameter set to include at least one of a standard parameter model or a baseline parameter model.

In another embodiment, as further discussed below, the vehicle operational assessments are particular to a corresponding subsystem of the vehicles.

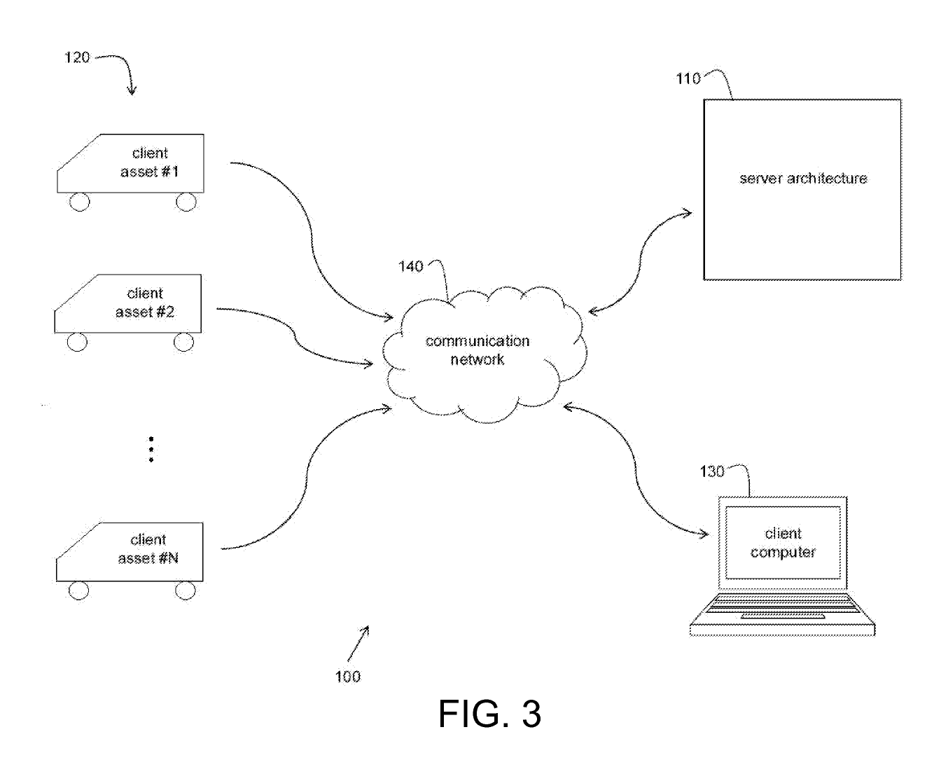

FIG. 3 is an illustration of an embodiment of a system 100 for characterizing the health of a set of vehicles or other client assets, ranking the vehicles or other client assets according to the characterized health, and allocating one or more of the vehicles or other client assets for movement along one or more routes, or for another task or mission. The system 100 includes a server architecture 110 and a plurality of vehicles or other client assets 120 (client asset #1 to client asset #N, where N represents some integer number). As shown in FIG. 3, the client assets may be mobile train locomotives belonging to, for example, a railroad client. The system 100 may also include a client computer 130 such as, for example, a personal laptop computer.

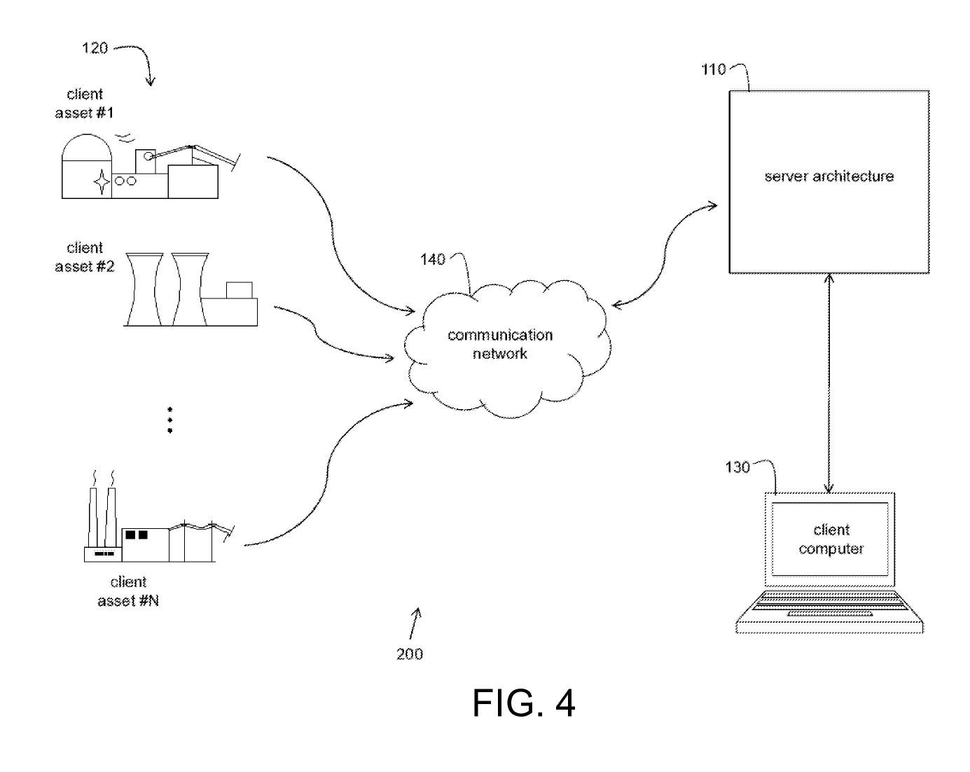

FIG. 4 is an illustration of an embodiment of a system 200 for characterizing the health of a set of client assets, ranking the client assets according to the characterized health, and allocating one or more of the client assets for a task or mission. In FIG. 4, the client assets are fixed power generating stations and the client computer 130 is directly connected to the server architecture 110 (i.e., the server architecture 110 and the client computer are co-located). The power generating stations may belong to, for example, a power generating company.

In accordance with an embodiment of the present invention, the client assets 120 and the server architecture 110 communicate with each other via a communication network 140. The client computer 130 and the server architecture 110 also communicate with each other via the communication network 140 (see FIG. 3). Where the server architecture 110, the client assets 120, and the client computer are remotely located with respect to each other, the communication network 140 may include a wide area network (WAN) having, for example, one or more of the internet, a cellular communication system, and a satellite communication system. Such a WAN allows communication between client assets 120 in the field and the server architecture 110 at, for example, a central logistics facility. The client computer 130 may be in the field or at some other facility, for example.

In other embodiments, where the elements of the system 100 are located more proximate to each other, the communication system may include a local area network (LAN) such as, for example, an Ethernet-based LAN or a Wi-Fi-based LAN. For example, the client assets 120 may be located on one side of a facility and the server architecture 110 and the client computer 130 may be located on the other side of the facility. Still, in other embodiments where the elements of the system 100 are located very proximate to each other, the communication system 140 may be simplified to a direct communication connection between the system elements. For example, the client assets 120, the server architecture 110, and the client computer 130 may all be co-located in a same room of a facility.

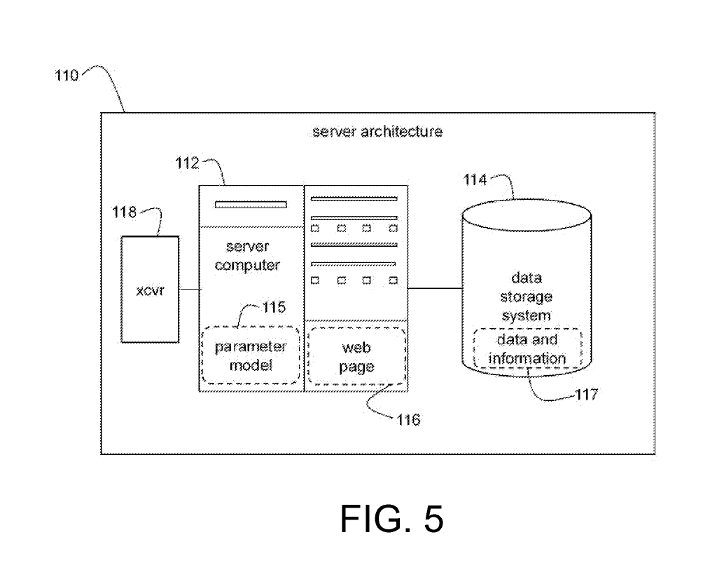

FIG. 5 is an illustration of an exemplary embodiment of a server architecture 110 used in the systems 100 and 200 of FIG. 3 and FIG. 4. (Aspects may also be applicable to the systems of FIGS. 1 and 2.) The system architecture 110 includes a server computer 112 communicatively connected to a data storage system 114. The server computer 112 hosts the software for performing the methods described herein of computing health scores for client assets, ranking client assets, and allocating client assets.

The data storage system 114 may be used to store data and information 117 such as, for example, operational parameter data received from client assets, mission parameters, as well as health scores, ranking information, principal components, and other information generated by the server computer 112, in accordance with the various methods performed by the server architecture 110. In accordance with certain optional embodiments, a parameter model 115 may be hosted on the server computer 112 or stored on the data storage system 114, depending on the embodied nature of the parameter model. As defined above, a parameter model may be a computer program, an electronic table, or some equivalent thereof being representative of a standard or baseline healthy asset. The server architecture 110 also includes a transceiver communication port 118 (“xcvr”)—(e.g., a modem) for receiving information from and/or transmitting information to the client assets 120 and the client computer 130 via the communication network 140 (or via direct communication).

In accordance with an embodiment, the server architecture 110 is configured as a software-as-a service (SaaS) product provided by a service provider, which is accessible by an authorized client via a client computer 130 through the communication network 140. For example, the server architecture 110 may allow a client to access a web page 116 of the server architecture 110 over the internet 140 via a client computer 130. Through a user interface provided by the web page 116, the client can direct the server architecture 110 to acquire sampled operational parameter data (values) from one or more client assets 120, compute health scores for the client assets, rank the client assets according to the health scores, and facilitate the allocating of one or more client assets to perform one or more tasks or missions. The SaaS configuration may provide services to a plurality of different clients for various types of client assets, for example.

In accordance with another embodiment, the server architecture 110 is configured to be installed at a client facility for use only by that client. The server architecture 110 may be customized for that particular client and the type of client assets owned and/or operated by the client. The client may access the server architecture 110 from a client computer 130 via a LAN within the client facility, or via a direct communication connection between the client computer 130 and the server computer 112.

In accordance with yet another embodiment, the server architecture is not present, and the functionality of acquiring operational parameter data, computing health scores, ranking client assets, and allocating client assets is implemented in a dedicated client computer 130 communicatively connected to a communication network 140. In such an embodiment, the client computer 130 does not function as a server to service, for example, multiple users. Instead, the client computer 130 may be dedicated to a particular user and a particular group of client assets, for example.

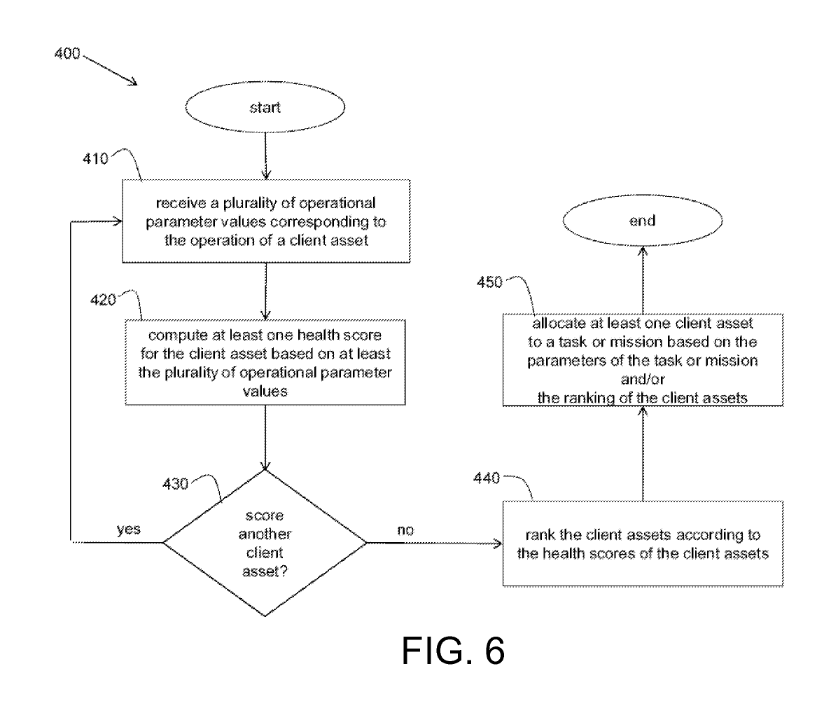

FIG. 6 illustrates a flow chart of an exemplary embodiment of a method 400 for characterizing the health of a set of vehicles or other client assets, ranking the vehicles or other client assets according to the characterized health, and allocating one or more of the vehicles or other client assets for a task or mission (e.g., for movement along one or more routes) using the system of FIG. 3 or FIG. 4. Aspects may also be applicable to the systems of FIGS. 1 and 2.

In step 410 of the method 400, a plurality of operational parameter values are received which correspond to the operation of a vehicle or other client asset. For example, if the client asset is a locomotive, the operational parameter values may be numerical values related to operational parameters including engine speed, torque output, water temperature, and/or air compressor pressure of the locomotive. If the client asset is a marine vessel, the operational parameter values may be numerical values related to operational parameters including engine temperature and oil pressure, for example.

Other types of client assets are possible as well including, for example, aircraft assets, portable communication device assets, portable data device assets, power generating station assets, water treatment center assets, data center assets, telecommunication station assets, and computer assets. Other types of operational parameters are possible as well including, for example, hydraulic fluid pressure, signal strength, and battery life.

In step 420 of the method 400, at least one health score is computed for the vehicle or other client asset based on at least the plurality of operational parameter values received. The health score is representative of a state of operational readiness of the client asset and is an indication of a relative or absolute operational capability or performance of the client asset. In accordance with an embodiment, the health score is computed by comparing the plurality of operational parameter values to a corresponding parameter model representative of a standard or baseline healthy asset (i.e., an absolute health score). The baseline may be derived from the client asset itself, corresponding to its own operational baseline performance. In accordance with an alternative embodiment, the health score is simply computed based on the sampled operational parameter values of the client asset itself, and not with respect to a standard or baseline (i.e., a relative health score).

In step 430 of the method 400, a decision is made as to whether or not to score another vehicle or other client asset. If another client asset is to be scored, then the method reverts back to step 410, otherwise, the method proceeds to step 440. In step 440 of the method 400, assuming there is more than one scored client asset, the client assets may be ranked according to the health scores of the client assets. In accordance with one embodiment, a higher health score corresponds to a healthier client asset. In accordance with another embodiment, a lower health score corresponds to a healthier client asset.

In step 450, at least one client asset is allocated to a task or a mission based on the ranking of the client assets, or based on a combination of the ranking of the client assets and the mission parameters associated with the mission or task. For example, a first locomotive that is ranked higher (is healthier) than a second locomotive may be allocated to go on a mission, whereas the second locomotive may be assigned to be serviced (for maintenance) before going on another mission, because of its low ranking and/or low health score. In another example, locomotives may be ranked according to health scores representative of a sub-system of the client assets such as, for example, a compressor brake sub-system of each locomotive. If the mission is a route through hilly terrain, all other things being substantially equal, the locomotive having the healthiest compressor brake sub-system may be allocated as having the best chance of completing the mission through the hilly terrain.

Furthermore, in accordance with an embodiment, a first client asset may be allocated to a first mission and a second client asset, having a lower ranking than the first client asset, may be allocated to a less critical second mission, for example. In general, one or more client assets may be assigned to one or more tasks or missions based on the rankings of the client assets. Once a client asset is allocated to a task or mission, that client asset may be operated to carry out the task or mission.

As alluded to herein, client assets can be scored in various ways. A client asset may be scored by computing an overall health score for the client asset. Such an overall health score may take into account operational parameter values from many sub-systems of the client asset. Alternatively, a client asset may be scored by computing a health score for a single sub-system of the client asset (e.g., a compressor brake sub-system). Such a sub-system health score may take into account operational parameter values associated with a single sub-system of the client asset.

In accordance with an embodiment, a respective health score may be computed for each of a plurality of sub-systems of a client asset and the plurality of sub-system health scores may be combined to form a total or composite client asset health score. For example, the health scores of the various sub-systems of a client asset may be computed, weighted (i.e., differently valued), and summed to compute the total client asset health score. Health scores of sub-systems may be weighted based on any of a number of factors including, but not limited to, criticality of the sub-system to mission performance, reliability of the sub-system, time to next scheduled maintenance of the sub-system, age of the sub-system, number of operational hours accrued by the sub-system, and sub-system model or technology type.

In accordance with an embodiment, where a parameter model is used as a standard or a baseline representative of a healthy client asset, the parameter model may be developed (e.g., trained) on a set of operational parameter values acquired from one or more healthy client assets. The set of operational parameter values may be selected for one or more sub-systems of a client asset. For example, if the client asset is a locomotive, the set of operational parameter values may be derived from signals sampled from the engine of a locomotive. The set of operational parameters values are acquired over a defined period of time (e.g., seven days) over which the one or more client assets have been determined to be operating in a healthy manner (i.e., the systems and sub-systems associated with the operational parameter values are determined to be functioning properly).

In accordance with an embodiment, when developing the parameter model, the operational parameter values are processed using a principal component analysis (PCA) technique which is a well-known mathematical technique. The PCA technique is used to convert the set of operational parameter values, which may be significantly correlated to each other, into a set of principal components which are linearly uncorrelated to each other. Employing the PCA technique may be desirable in order to identify trends in the operational parameter data during the defined period of time over which the operational parameter values are acquired.

A set of principal components are selected to be retained in the parameter model. For example, in accordance with an embodiment, a number of principal components are selected that account for about 75% of the variation in the operational parameter data. Subsequently, when operational parameter values are acquired over a similar defined period of time for a client asset (which may or may not be a healthy client asset), the operational parameter values are compared to the principal components of the parameter model. The amount of deviation from the parameter model is indicative of a level of health of the client asset. The greater the amount of deviation from the parameter model, the less healthy is the client asset.

In accordance with an embodiment, the amount of deviation is computed by calculating the Q-statistic for each sampled operational parameter value. The computation of a Q-statistic is a well known mathematical technique. A Q-statistic is computed by comparing a data value to a nearest value in a baseline or standard set of data (e.g., a parameter model). The Q-statistic data may then be summarized, for example, by computing a median of the Q-statistic data, in accordance with an embodiment. The median quantifies a general condition of a client asset and is robust to outliers. The median may serve as the health score of the client asset.

When computed for a plurality of client assets, the client assets may be ranked according to the summary statistics (health scores). The ranking of the client assets may be used to allocate one or more of the client assets to one or more tasks or missions. Mission parameters of the tasks or missions may also factor into the allocating as described previously herein.

As a simplified example, a parameter model for a class of vehicles might indicate that: a nominal value for a given operational parameter for the class of vehicles is “X+−2%;” deviations above or below the nominal value are indicative of relatively less healthy vehicles; and deviations above the nominal value are relatively more indicative of a lower degree of health than deviations below the nominal value. That is, a value of at/within 2% of X (X=numerical value) is nominal and indicative of a relatively healthy vehicle, values below 98% of X are indicative of a relatively less healthy vehicle, and values above 102% of X are indicative of the relatively least healthy vehicles. The operational parameter could be engine coolant temperature at idle for ten minutes, just as one hypothetical example. For plural vehicles of the class of vehicles, the operational parameter would be measured, and respective values of the measured operational parameter would be used to compute health scores for the vehicles. For example, for a relative computation of three vehicles, a first of the three vehicles with an operational parameter value closest to at/within 2% of X might be given a health score of 100, a second of the three vehicles with an operational parameter value at 5% less than X might be given a health score of 95 (e.g., each percentage below X is reduced from a maximum possible of 100), and a third of the vehicles with an operational value at 10% more than X might be given a health score of 80 (e.g., each percentage above X is reduced from the maximum of 100, but with a 2-times multiplier). Here, “100” would represent the relatively best health score out of the three, and “95” and “80” would represent relatively lower health scores. For a given mission requiring two vehicles, where the operational parameter might be of importance in regards to mission success, the first and second vehicles would be chosen for the mission based on having the relatively best health scores out of the three vehicles.

In another embodiment, a method (e.g., for controlling client assets) comprises generating respective health scores for a plurality of client assets based on respective operational parameter values of the client assets in operation. For example, for each client asset, operational parameter values of the client asset in operation may be sensed or otherwise determined, and communicated to a central office or other control facility. The method further comprises ranking the plurality of client assets according to the health scores, and selecting one or more first selected client assets of the plurality of client assets for a first mission based at least in part on the ranking. The one or more first selected client assets may be operated to carry out the first mission.

In another embodiment of the method, the step of selecting comprises omitting at least one of the plurality of client assets from the one or more first selected assets based at least in part on the ranking. That is, based on the ranking, fewer than all of the client assets are selected for the first mission.

In another embodiment of the method, the method further comprises selecting one or more second selected client assets of the plurality of client assets for a second mission based at least in part on the ranking. In some embodiments, the second selected client assets are exclusive of the one or more first selected client assets; that is, none of the second selected client assets are also first selected assets. This may be for instances where the first and second missions are to be carried out concurrently, or at least partially overlap in time. Alternatively, if the first and second missions do not overlap in time, the first and second selected client assets may include common members. In an embodiment, the one or more second selected client assets are relatively lower ranked in the ranking than the one or more first selected client assets, which might be the case if: the first mission is relatively more important (according to one or more designated criteria) than the second mission; or the first selected client assets are relatively more important (according to one or more designated criteria) to the success of the first mission (e.g., meeting designated objectives of the mission) than the second selected client assets are to the success of the second mission. For example, if the first mission is deemed critical to complete within a first designated time frame, whereas the second mission is not deemed critical to complete generally, then the first selected client assets, being relatively higher ranked, would be more important to the first mission. That is, the first selected client assets are higher ranking in regards to health than the second selected client assets, meaning the former are less likely to fail during the first mission.

In another embodiment, the health scores are generated relative to one another. For example, operational parameter values of a first client asset may be compared to those of a second client asset. Whichever of the first and second client assets is deemed to be in a condition that is indicative of a higher degree of health, that client asset is given a higher health score than the other client asset. This may be done iteratively for all client assets being scored. In other embodiments, the health scores are generated relative to one or more absolute criteria. For example, for each operational parameter value for a given client asset, the operational parameter value may be compared to a predetermined scale that indicates whether and to what extent the operational parameter value is indicative of asset health, for the class of client asset and operational parameter.

In another embodiment, client assets are ranked according to the health scores relative to respective chances of failure of the client assets for performing the first mission. For example, client assets that are deemed more likely to fail if deployed for carrying out the first mission are ranked lower, and client assets that are deemed less likely to fail if deployed for carrying out the first mission are ranked higher.

Another embodiment relates to a system comprising a first means for receiving a plurality of first operational parameter values corresponding to the operation of a client asset, and a second means for computing at least one health score for the client asset based on at least the plurality of first operational parameter values. The first means may comprise a computer or other processor-based unit having access to non-transitory computer readable media having stored instructions thereon, that when executed by the computer or other processor-based unit, cause the computer or other processor-based unit to receive the plurality of first operational parameter values. The first means may additionally or alternatively include communication equipment (e.g., transceivers, physical communication links such as conductors to receive signals, and/or the like) for receiving the values. Other examples of possible equipment for the first means are set forth elsewhere herein. The second means may also comprise a computer or other processor-based unit having access to non-transitory computer readable media having stored thereon instructions, that when executed by the computer or other processor-based unit, cause the computer or other processor-based unit to compute the at least one health score. The computer or other processor-based unit of the second means could be the same computer or other processor-based unit as the first means, but with different sets of instructions stored in the media for receiving and computing, for example. Other examples of possible equipment for the second means are set forth elsewhere herein.

Another embodiment relates to a system comprising a first means for determining respective client asset health scores for a plurality of client assets, a second means for ranking the plurality of client assets according to the client asset health scores of the plurality of client assets, a third means for allocating at least one of the plurality of client assets to perform a task based on at least the ranking of the plurality of client assets, and a fourth means for allocating at least one client asset of the plurality of client assets to perform a mission based on a ranking of the at least one client asset of the plurality of client assets and further based on mission parameters of a potential mission for the at least one client asset of the plurality of client assets. The first means may comprise a computer or other processor-based unit having access to non-transitory computer readable media having stored instructions thereon, that when executed by the computer or other processor-based unit, cause the computer or other processor-based unit to compute respective client asset health scores for a plurality of client assets. Other examples of possible equipment for the first means are set forth elsewhere herein. The second means may also comprise a computer or other processor-based unit having access to non-transitory computer readable media having stored thereon instructions, that when executed by the computer or other processor-based unit, cause the computer or other processor-based unit to rank the plurality of client assets according to the client asset health scores of the plurality of client assets. The computer or other processor-based unit of the second means could be the same computer or other processor-based unit as the first means, but with different sets of instructions stored in the media for computing and ranking, for example. Other examples of possible equipment for the second means are set forth elsewhere herein. The third means may also comprise a computer or other processor-based unit having access to non-transitory computer readable media having stored thereon instructions, that when executed by the computer or other processor-based unit, cause the computer or other processor-based unit to allocate at least one of the plurality of client assets to perform a task based on at least the ranking of the plurality of client assets. The computer or other processor-based unit of the third means could be the same computer or other processor-based unit as the first or second means, but with different sets of instructions stored in the media for performing the allocating, for example. Other examples of possible equipment for the second means are set forth elsewhere herein. The fourth means may also comprise a computer or other processor-based unit having access to non-transitory computer readable media having stored thereon instructions, that when executed by the computer or other processor-based unit, cause the computer or other processor-based unit to allocate at least one of the plurality of client assets to perform a mission based on a ranking of the at least one client asset of the plurality of client assets and further based on mission parameters of a potential mission for the at least one client asset of the plurality of client assets. The computer or other processor-based unit of the fourth means could be the same computer or other processor-based unit as the first, second, or third means, but with different sets of instructions stored in the media for performing the allocating, for example. Other examples of possible equipment for the second means are set forth elsewhere herein.

Methods and systems are disclosed to analyze (fuse) a set of data for an asset, such as performance operation data collected from asset operation, maintenance records, periodical inspection data (e.g., oil samples taken from a locomotive), or incidents generated by on-board control systems, and summarize the set of data into a health score for the asset. The health score may be based on a relative comparison, for example, comparing an asset to other assets in a fleet of assets. Alternatively, the health score may be based on a deviation from a standard or baseline which is represented in, for example, a parameter model. Based on health scores for client assets, a fleet of client assets may be ranked, and a particular client asset may be allocated to a particular task or mission based on the ranking.

In one embodiment, a method is provided. The method includes receiving a plurality of first operational parameter values corresponding to operation of a client asset, and computing at least one health score for the client asset based on at least the plurality of first operational parameter values. Computing at least one health score may be done relative to the client asset, and not with respect to a standard or a baseline. Alternatively, computing at least one health score may include comparing the plurality of first operational parameter values to a corresponding parameter model representative of a healthy client asset. The parameter model may include a plurality of principal components derived from a plurality of second operational parameter values representative of the healthy asset that comprises a healthy client asset. A health score of the client asset may be one of a plurality of health scores corresponding to differing assets in a group of client assets. A health score may be particular to a sub-system of the client asset, or to a plurality of sub-systems of the client asset where the health score comprises a plurality of health scores relating to the plurality of sub-systems of the client asset that are combinable to produce a composite health score for the client asset. A health score may represent a total deviation of the plurality of first operational parameter values from the parameter model. In accordance with an embodiment, the plurality of first operational parameter values are sampled during operation of the client asset over a determined length of time, and the parameter model is generated based on a plurality of second operational parameter values sampled from at least one healthy asset over a same determined length of time.

In one embodiment, a method is provided. The method includes determining respective client asset health scores for a plurality of client assets according to at least a portion of the method described above herein, and ranking the plurality of client assets according to the client asset health scores of the plurality of client assets. The method may further include allocating at least one of the plurality of client assets to perform a mission based on at least the ranking of the client assets. The method may further include allocating at least one of the plurality of client assets to perform a mission based on the ranking and on mission parameters of a potential mission for at least one of the plurality of client assets. Each client asset health score of each client asset of the plurality of client assets may be a composite of a plurality of sub-system health scores corresponding to sub-systems of the client asset. Ranking the plurality of client assets may be based at least in part on weighting or differently valuing the sub-system health scores relative to each other. Certain sub-systems may be weighted differently from each other based on mission parameters, for example.

In one embodiment, a method is provided. The method includes generating respective health scores for a plurality of client assets based on respective operational parameter values of the client assets in operation. The health scores may be generated relative to one another or relative to one or more absolute criteria. The method also includes ranking the plurality of client assets according to the health scores, and selecting one or more first selected client assets of the plurality of client assets for a first mission based at least in part on the ranking. The client assets may be ranked according to the health scores relative to respective chances of failure of the client assets for performing the first mission. Selecting one or more first selected client assets may include omitting at least one of the plurality of client assets from the one or more first selected assets based at least in part on the ranking. The method may also include operating the one or more first selected client assets to carry out the first mission. The method may further include selecting one or more second selected client assets of the plurality of client assets for a second mission based at least in part on the ranking. The second selected client assets may be exclusive of the one or more first selected client assets, and the one or more second selected client assets may be relatively lower ranked in the ranking than the one or more first selected client assets.

In one embodiment, a system is provided. The system includes means for receiving a plurality of first operational parameter values corresponding to the operation of a client asset, and means for computing at least one health score for the client asset based on at least a plurality of first operational parameter values. The means for computing at least one health score may compute the at least one health score relative to the client asset, and not with respect to a standard or a baseline. Alternatively, the means for computing at least one health score may include means for comparing a plurality of first operational parameter values to a corresponding parameter model representative of a healthy client asset. The parameter model may include a plurality of principal components derived from a plurality of second operational parameter values representative of the healthy asset being a healthy client asset.

In one embodiment, a system is provided. The system includes means for determining respective client asset health scores for a plurality of client assets using at least a portion of the system described above herein, and means for ranking the plurality of client assets according to the client asset health scores of the plurality of client assets. The system may further include means for allocating at least one of the plurality of client assets to perform a task based on at least a ranking of the client assets. The system may further include means for allocating at least one of the plurality of client assets to perform a mission based on a ranking of the client assets and on mission parameters of a potential mission for at least one of the plurality of client assets. The system may further include a plurality of client assets, wherein the plurality of client assets includes one of a fleet of locomotives, a fleet of aircraft, a fleet of forklifts, a fleet of military vehicles, a fleet of mining/earth-moving vehicles, a fleet of trucks, a fleet of automobiles, or a fleet of marine vessels. The system may further include a plurality of client assets, wherein the plurality of client assets includes one or more of a power generating station, a water treatment center, a data center, or a computer asset.

In one embodiment, a system is provided. The system includes a server computer, a data storage system operable to communicate with the server computer, and a transceiver operable to communicate with the server computer and an external device. The transceiver is operable to receive a plurality of first operational parameter values corresponding to the operation of a client asset and pass the plurality of first operational parameter values to the server computer. The server computer is operable to compute at least one health score for the client asset based on at least the plurality of first operational parameter values. The server computer may also be operable to compute the at least one health score relative to the client asset, and not with respect to a standard and/or a baseline. Alternatively, the server computer may be operable to compute the at least one health score by comparing the plurality of first operational parameter values to a corresponding standard parameter model and/or baseline parameter model representative of a healthy client asset. The parameter model may include a plurality of principal components derived from a second plurality of operational parameter values representative of a healthy client asset. The server computer may also be operable to compute respective client asset health scores for a plurality of client assets based on respective first operational parameter values, and rank the plurality of client assets according to the client asset health scores of the plurality of client assets. The server computer may further be operable to allocate at least one client asset of the plurality of client assets to perform a task based on at least a ranking of the plurality of client assets. The server computer may also be operable to allocate at least one client asset of the plurality of client assets to perform a mission based on a ranking of the at least one client asset of the plurality of client assets, and further based on mission parameters of a potential mission for the at least one client asset of the plurality of client assets.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A vehicle control system comprising:
a transceiver configured to communicate over one or more communication channels with plural communication units on board respective plural vehicles; and
a control unit having a processor, the control unit operably coupled to the transceiver;
wherein the transceiver is configured to receive respective pluralities of first operational parameter values from the plural vehicles over the one or more communication channels, wherein the respective pluralities of first operational parameter values are generated at least in part by sensors on board the vehicles and relate at least in part to operation of the vehicles during movement of vehicles along one or more routes;
wherein the control unit is configured to generate plural respective vehicle operational assessments of the vehicles based at least in part on the pluralities of first operational parameter values received from the vehicles, the vehicle operational assessments being representative of respective states of operational readiness of the vehicles;
wherein the control unit is further configured to determine respective operational capabilities of the vehicles to operate along one or more designated routes according to one or more designated criteria, based at least in part on the vehicle operational assessments that are generated; and
wherein the control unit is further configured to generate control signals, relating to control of the vehicles for operation along the one or more designated routes, based on the operational capabilities that are determined, the control signals being configured to control at least one device that is off board the vehicles or on board at least one of the vehicles.

2. The system of claim 1, wherein the control unit is configured to generate each operational assessment of the plural operational assessments relative to the vehicle associated with the operational assessment and not with respect to a standard and/or a baseline.

3. The system of claim 1, wherein the control unit is configured to generate each operational assessment of the plural operational assessments by comparing the first operational parameter values of the vehicle associated with the operational assessment to a corresponding parameter set representative of a vehicle having a designated condition.

4. The system of claim 3, wherein the operational assessment represents a total deviation of the first operational parameter values of the vehicle associated with the operational assessment from the parameter set.

5. The system of claim 3, wherein the respective pluralities of first operational parameter values of the plural vehicles are further generated by sampling outputs of the sensors over a determined length of time during operation of the vehicles, and wherein the control unit is configured to generate the parameter set based on a plurality of second operational parameter values received from the vehicle having the designated condition, the plurality of second operational parameter values sampled from sensor outputs of sensors on board the vehicle having the designated condition over the determined length of time.

6. The system of claim 3, wherein the control unit is configured to generate the parameter set to include a plurality of principal components derived from a plurality of second operational parameter values received from the vehicle having a designated condition.

7. The system of claim 3, wherein the control unit is configured to generate the parameter set to include at least one of a standard parameter model or a baseline parameter model.

8. The system of claim 1, wherein the vehicle operational assessments are particular to a corresponding subsystem of the vehicles.

9. The system of claim 1, wherein the control unit is configured to generate the control signals based on a ranking of the operational assessments relative to one another.

10. A vehicle control system comprising:
a transceiver configured to communicate over one or more communication channels with plural communication units on board respective plural vehicles; and
a control unit having a processor, the control unit operably coupled to the transceiver;
wherein the transceiver is configured to receive respective pluralities of first operational parameter values from the plural vehicles over the one or more communication channels, wherein the respective pluralities of first operational parameter values are generated at least in part by sensors on board the vehicles and relate at least in part to operation of the vehicles during movement of vehicles along one or more routes;
wherein the control unit is configured to generate plural respective vehicle operational assessments of the vehicles based at least in part on the pluralities of first operational parameter values received from the vehicles, the vehicle operational assessments being representative of respective states of operational readiness of the vehicles; and
wherein the control unit is further configured to generate control signals, relating to control of the vehicles for operation along one or more designated routes, based on the vehicle operational assessments, the control signals being configured to control at least one device that is off board the vehicles or on board at least one of the vehicles.

11. The system of claim 10, wherein the control unit is configured to generate each operational assessment of the plural operational assessments relative to the vehicle associated with the operational assessment and not with respect to a standard and/or a baseline.

12. The system of claim 10, wherein the control unit is configured to generate each operational assessment of the plural operational assessments by comparing the first operational parameter values of the vehicle associated with the operational assessment to a corresponding parameter set representative of a vehicle having a designated condition.

13. The system of claim 12, wherein the operational assessment represents a total deviation of the first operational parameter values of the vehicle associated with the operational assessment from the parameter set.

14. The system of claim 12, wherein the respective pluralities of first operational parameter values of the plural vehicles are further generated by sampling outputs of the sensors over a determined length of time during operation of the vehicles, and wherein the control unit is configured to generate the parameter set based on a plurality of second operational parameter values received from the vehicle having the designated condition, the plurality of second operational parameter values sampled from sensor outputs of sensors on board the vehicle having the designated condition over the determined length of time.

15. The system of claim 12, wherein the control unit is configured to generate the parameter set to include a plurality of principal components derived from a plurality of second operational parameter values received from the vehicle having a designated condition.

16. The system of claim 12, wherein the control unit is configured to generate the parameter set to include at least one of a standard parameter model or a baseline parameter model.

17. The system of claim 10, wherein the vehicle operational assessments are particular to a corresponding subsystem of the vehicles.

18. The system of claim 10, wherein the control unit is configured to generate the control signals based on a ranking of the operational assessments relative to one another.
